(19) United States
(12) Patent Application Publication
(10) Pub. No.: US 2007/0097414 A1
(43) Pub. Date: May 3, 2007

(54) IMAGE PROCESSING APPARATUS, IMAGE FORMING APPARATUS AND RELATED CONTROL METHOD

(75) Inventor: Takuto Harada, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/550,253

(22) Filed: Oct. 17, 2006

(30) Foreign Application Priority Data
Oct. 31, 2005 (JP) 2005-316714
Aug. 25, 2006 (JP) 2006-228962

(51) Int. Cl. G06F 3/12

(52) U.S. Cl. 358/1.14; 358/1.13

(57) ABSTRACT

A printing apparatus, or a multifunction peripheral connected via a network, can store images having individual identification (ID). The devices can extract inherent identification (ID) from a document and can retrieve, from a storage device, a pre-stored image having identification (ID) corresponding to the extracted identification (ID), and can compose visualized copy-forgery-inhibited-pattern information on the retrieved image and form a composite image on a recording paper.

### BACKGROUND OF THE INVENTION

1. Field of the Invention

The present invention relates to an image processing apparatus, an image forming apparatus, and related control methods.

2. Description of the Related Art

In general, a copying machine can optically read a printed image on a paper and can produce image data. According to a conventional technique, a same hidden identification (ID) can be embedded into a printed product produced by a printer and the image data. For example, a storage device of an apparatus connected via a network can temporary store the image data containing the hidden identification (ID). The system can retrieve and print the stored image data based on the identification (ID) of the printed product, if a user instructs a copy of the printed product created by the printer (refer to Japanese Patent Application Laid-open No. 10-308868). Thus, when the quality of a printed product deteriorates, a user can obtain a high quality printed product by instructing a copy of the printed product.

Moreover, careful management of printout documents becomes very important to enhance the security. The copy-forgery-inhibited-pattern (hereinafter, referred to as “cfip”) printing technique is preferably usable for the document management. In general, the reproduction capability of a copying machine (or a scanner) is dependent on its resolution. The cfip printing technique is characteristic in utilizing the limit of reproducibility in each copying machine (or a scanner).

The cfip image may include a hidden character string pattern, such as “COPY”, which can be composed with an image of contents and printed on a recording paper. When the printout document is copied, the hidden character string pattern such as “COPY” becomes visible on a copy product (refer to Japanese Patent Application Laid-open No. 2001-324898).

Although a copy product is obtainable by copying a printed product containing a cfip and document contents, a person who obtained the copy will recognize the character string pattern on the paper and may hesitate to unlawfully use or distribute the obtained information, or may understand the importance of the obtained information. In this manner, the copy-forgery-inhibited-pattern has an effect of mentally inhibiting a user from making an unauthorized copy of important or confidential information, and therefore can assure the security to a certain extent.

The cfip image will be described below in more detail. The cfip image may include a hidden character string pattern, such as “COPY”, which cannot be recognized at a glance by human eyes. However, when the cfip image is copied, the hidden character string pattern becomes visible on a copy product. Therefore, the original (i.e., a document paper including a cfip) can be clearly discriminated from its copy product. Furthermore, because a character string pattern such as “COPY” is visible on a copy product, a person who obtained the copy product will hesitate to use or distribute the copied information.

The cfip image generally includes two regions. One region is an area “remaining” on a copy product when copied. The other region is an area “disappearing” (or “being thinned in density compared to the remaining area) when copied. The “remaining” area and the “disappearing” area may be substantially identical with each other in reflection density on the original. Therefore, human eyes may not recognize the presence of a hidden character, such as “C.” In the following description, the “remaining” area is an area where the image of the original can be accurately reproduced on a copy product. In contrast, the “disappearing” area is an area where the image of the original cannot be reproduced on a copy product. In practice, a reflection density meter can be used to measure the reflection density.

In the context of the present disclosure, the area “remaining” on the copy product is referred to as a “latent area of the cfip image.” The area “disappearing” from the copy product (or the area being thinned in density compared to the “remaining” area) is referred to as a “background area of the cfip image.”

FIG. 17 shows an exemplary dot pattern 1701 of the cfip image. In FIG. 17, a concentrated dot area is the latent area of the cfip image and a dispersed dot area is the background area of the cfip image. The different dot areas can be produced using different dot processing or different dither processing.

For example, lower line number dot processing can be used to produce the dots in the latent area of the cfip image and higher line number dot processing can be used to produce the dots in the background area of the cfip image. Alternatively, a dot concentrated type dither matrix can be used to produce the dots in the latent area of the cfip image. A dot dispersed type dither matrix can be used to produce the dots in the background area of the cfip image.

In general, the reproduction capability of a copying machine is dependent on the input resolution or the output resolution of the copying machine. Accordingly, the reproduction capability of a copying machine is limited by the input resolution and/or the output resolution thereof. Therefore, when the dot in the latent area of the cfip image has a size larger than “a dot reproducible by a copying machine” and the dot in the background area of the cfip image is smaller than the “dot reproducible by a copying machine,” the dots in the latent area of the cfip image can be reproduced on a copy product and the dots in the background area cannot be reproduced.

As a result, the latent area of the cfip image reproduced on the copy product can be recognized as an area having higher density compared to the background area of the cfip image. The above-described phenomenon can be referred to as “visualization.”

FIG. 17 shows a visualized example 1702, schematically illustrating concentrated dots (i.e., larger dots) being reproduced on a copy product and dispersed dots (i.e., smaller dots) not being accurately reproduced on the copy product. In the following description, the cfip image obtainable by the visualization is referred to as a visualized cfip image. As described above, the visualized cfip image can be generally obtained by copying the cfip image.

It is also possible to produce the visualized cfip image data in the following manner. First, concentrated dots (larger dots) are disposed in a “visualized latent area of the cfip image. In contrast, no dots (or dots being thinned in density compared to the “visualized latent area of the cfip image”) are disposed in a “visualized background area of the cfip image.” In the present specification, the visualized cfip image data may be referred to as “stamp image data” and the visualized cfip image may be referred to as a “stamp image.” The stamp image is an image to be composed with the document image and can be constituted as a character string pattern such as “CONFIDENTIAL”, which can be clearly recognized by human eyes.

When a copy instruction of a printed product containing the above-described identification information is issued, a corresponding image is read out of a storage device and a high quality copy product can be outputted. However, important information may leak due to the nature of copy products. Hence, it is desirable to provide a mechanism for adding a stamp image to a high quality image read out of a storage unit in response to an instruction to copy an image on the sheet.

### SUMMARY OF THE INVENTION

Embodiments of the present invention are directed to a technique capable of overcoming or at least mitigating the above-described problems.

According to an aspect of the present invention, at least one exemplary embodiment is directed to an image forming apparatus that includes a storage processing unit configured to store a document image and a stamp image into a storage unit; a composing unit configured to compose the document image stored by the storage processing unit with a copy-forgery-inhibited-pattern image to produce a composite image; and a forming unit configured to form the composite image produced by the composing unit on a sheet, wherein when a copy instruction of the sheet is issued, the document image and the stamp image are read out of the storage unit, and the readout document image and the stamp image are composed and formed on a sheet.

According to another aspect of the present invention, at least one exemplary embodiment is directed to an image processing apparatus including: a storage unit configured to store a stamp image and a document image which are correlated with each other, wherein the stamp image is different from a copy-forgery-inhibited-pattern image; and an instruction issuing unit configured to issue an instruction for composing the document image and the stamp image mutually correlated and stored in the storage unit and forming a composite image on a sheet, in response to a copy instruction of a sheet including the document image and the copy-forgery-inhibited-pattern image composed and formed thereon.

While, according to another aspect of the present invention, at least one exemplary embodiment is directed to an image processing apparatus including: a storage unit configured to store document image; and an issuing unit configured to issue an instruction for composing the document image stored in the storage unit with a copy-forgery-inhibited-pattern image and forming a composite image on a sheet, or an instruction for composing the document image stored in the storage unit with a stamp image different from the copy-forgery-inhibited-pattern image and forming a composite image on a sheet, which is selected based on user information in response to a copy instruction of a sheet created by printing output the document image.

Still yet, according to another aspect of the present invention, at least one exemplary embodiment is directed to an image processing system including an image forming apparatus and an image processing apparatus. The image forming apparatus includes: a forming unit configured to form a document image on a sheet; and a storage processing unit configured to store the document image formed on the sheet by the forming unit into a storage unit of the image processing apparatus. The image processing apparatus includes an issuing unit configured to issue an instruction for composing the document image stored in the storage unit with a copy-forgery-inhibited-pattern image and forming a composite image on a sheet, or an instruction for composing the document image stored in the storage unit with a stamp image different from the copy-forgery-inhibited-pattern image and forming a composite image on a sheet, which is selected in response to a copy instruction of a sheet on which the document image is formed.

According to another aspect of the present invention, at least one exemplary embodiment is directed to an image processing system including: an issuing unit configured to select an instruction for composing the document image stored in the storage unit with a copy-forgery-inhibited-pattern image and forming a composite image on a sheet, when information of a user having instructed creation of the document image agrees with information of a user issuing the copy instruction of the sheet on which the document image is formed, and the issuing unit selects an instruction for composing the document image stored in the storage unit with the stamp image different from the copy-forgery-inhibited-pattern image and forming a composite image on a sheet, when the information of the user having instructed creation of the document image disagrees with the information of the user issuing the copy instruction of the sheet on which the document image is formed.

Moreover, according to an aspect of the present invention, at least one exemplary embodiment is directed to a method for an image forming apparatus, including storing a document image and a stamp image in a storage unit, wherein the stamp image is different from a copy-forgery-inhibited-pattern image; composing the document image stored in the storage unit with the copy-forgery-inhibited-pattern image to produce a composite image; and forming the composite image on a sheet, wherein when a copy instruction of the sheet is issued, the document image and the stamp image are read out of the storage unit, and the readout document image and the stamp image are composed and formed on a sheet.

Yet, according to another aspect of the present invention, at least one exemplary embodiment is directed to a method for an image processing apparatus including a storage unit configured to store a document image and a stamp image which are correlated, wherein the stamp image is different from a copy-forgery-inhibited-pattern image, the method including issuing an instruction for composing the document image and the stamp image mutually correlated and stored in the storage unit and forming a composite image on a sheet, in response to a copy instruction of a sheet including the document image and the copy-forgery-inhibited-pattern image composed and formed thereon.

Moreover, according to an aspect of the present invention, at least one exemplary embodiment is directed to a method for an image processing apparatus including a storage unit configured to store document image, the method including: issuing an instruction for composing the document image stored in the storage unit with a copy-forgery-inhibited-pattern image and forming a composite image on a sheet, or an instruction for composing the document image stored in the storage unit with a stamp image different from the copy-forgery-inhibited-pattern image and forming a composite image on a sheet, which is selected based on user information in response to a copy instruction of a sheet created by printing output the document image.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a schematic block diagram illustrating an arrangement of a printing system in accordance with an exemplary embodiment.

FIG. 2 is a schematic block diagram illustrating an arrangement of software modules, hardware components, and data in the printing system shown in FIG. 1.

FIG. 3 is a flowchart showing a print processing procedure of the printing system in accordance with an exemplary embodiment.

FIG. 4 is a flowchart showing PDL processing performed by the printing system in accordance with a first exemplary embodiment.

FIG. 5 is a flowchart showing storage selection processing performed in accordance with the first exemplary embodiment.

FIG. 6 is a flowchart showing storage retrieval processing performed in accordance with the first exemplary embodiment.

FIG. 7 is a flowchart showing storage processing performed in accordance with the first exemplary embodiment.

FIG. 8 is a flowchart showing copy processing performed in accordance with the first exemplary embodiment.

FIG. 9 is a view showing a packet that a data transmitting section can broadcast in accordance with the first exemplary embodiment.

FIG. 10 is a view showing a packet usable, when storage of document image data is feasible, in accordance with the first exemplary embodiment.

FIG. 11 is a view showing a packet, usable to read information from identification (ID) and issue a storage extraction request, in accordance with the first exemplary embodiment.

FIG. 12 is a view showing a packet returned from a storage destination device that received the storage extraction request.

FIG. 13 is a flowchart showing image data extraction processing performed according to the first exemplary embodiment.

FIG. 14 is a schematic block diagram illustrating a printing system in accordance with an exemplary embodiment.

FIG. 15 is a flowchart showing driver processing performed in accordance with an exemplary embodiment.

FIG. 16 is a fundamental flowchart showing a print processing procedure of the printing system shown in FIG. 14.

FIG. 17 is a view illustrating a cfip image and a visualized cfip image.

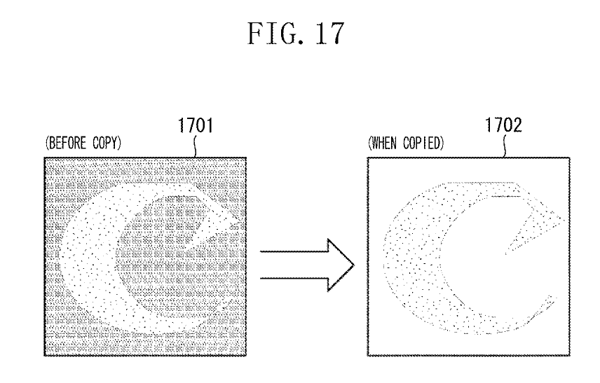

FIG. 18 is a flowchart showing image data extraction processing performed according to another exemplary embodiment.

### DETAILED DESCRIPTION OF THE EMBODIMENTS

The following description of exemplary embodiments is merely illustrative in nature and is in no way intended to limit the invention, its application, or uses.

Processes, techniques, apparatus, and others as known by one of ordinary skill in the art may not be discussed in detail but are intended to be part of the enabling description where appropriate.

For example, certain circuitry for signal processing, calculating, and other uses may not be discussed in detail. However these systems and the methods to fabricate these system as known by one of ordinary skill in the relevant art is intended to be part of the enabling disclosure herein where appropriate.

It is noted that throughout the specification, similar reference numerals and letters refer to similar items in the following figures, and thus once an item is defined in one figure, it may not be discussed for following figures.

Exemplary embodiments will be described in detail below with reference to the drawings.

First Exemplary Embodiment

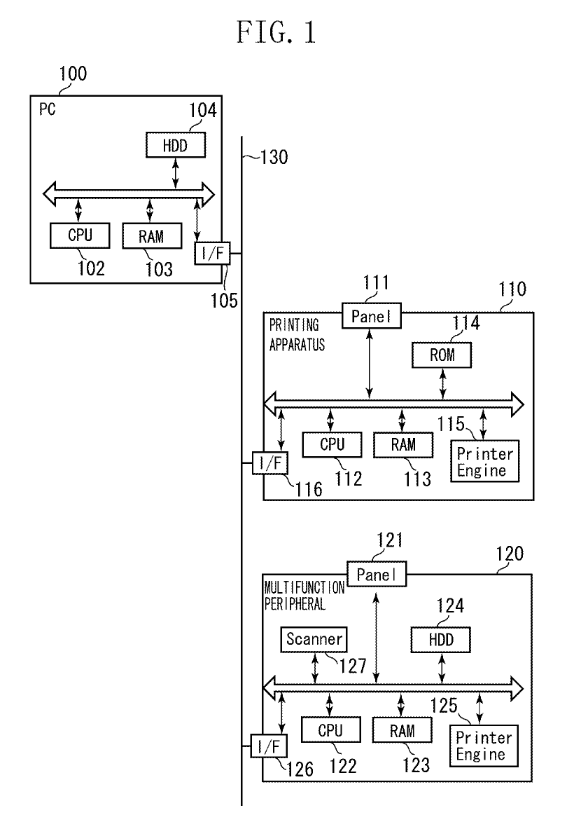

FIG. 1 is a schematic block diagram illustrating an arrangement of a printing system that can read image data of a scanned document from a storage device and can print an image on a recording paper. As shown in FIG. 1, the printing system includes a host computer 100, a printing apparatus (i.e., a printer) 110, and a multifunction peripheral 120 which are mutually connected via a network 130 (e.g., LAN).

The host computer 100 includes a CPU 102, a RAM 103, and a hard disk (HDD) 104. The CPU 102 can control various processing performed in the host computer 100. The RAM 103 can be used as a work area of the CPU 102 or a data storage portion. The HDD 104 can store software. A communication interface 105 can control data transmission/reception between the host computer 100 and other apparatus performed via the network 130.

The printing apparatus 110 includes a panel 111, a CPU 112, a RAM 113, a ROM 114, a printer engine 115, and a communication interface 116. The panel 111 enables a user to perform operational settings for the printing apparatus 110. The CPU 112 can control various processing performed in the printing apparatus 110. The RAM 113 can be used as a work area of the CPU 112 or a data storage portion. The ROM 114 can store software. The printer engine 115 can form a print image on a recording paper based on received image data. The communication interface 116 can control data transmission/reception between the printing apparatus 110 and other apparatus performed via the network 130.

The multifunction peripheral 120 includes a panel 121, a CPU 122, a RAM 123, a hard disk (HDD) 124, a printer engine 125, a communication interface 126, and a scanner 127. The panel 121 enables a user to perform operational settings for the multifunction peripheral 120. The CPU 122 can control various processing performed in the multifunction peripheral 120.

The RAM 123 can be used as a work area of the CPU 122 or a data storage portion. The HDD 124 can store software. The printer engine 125 can form a print image on a recording paper based on received image data. The communication interface 126 can control data transmission/reception between the multifunction peripheral 120 and other apparatus performed via the network 130. The scanner 127 can optically read a printed product and produce an electronic image.

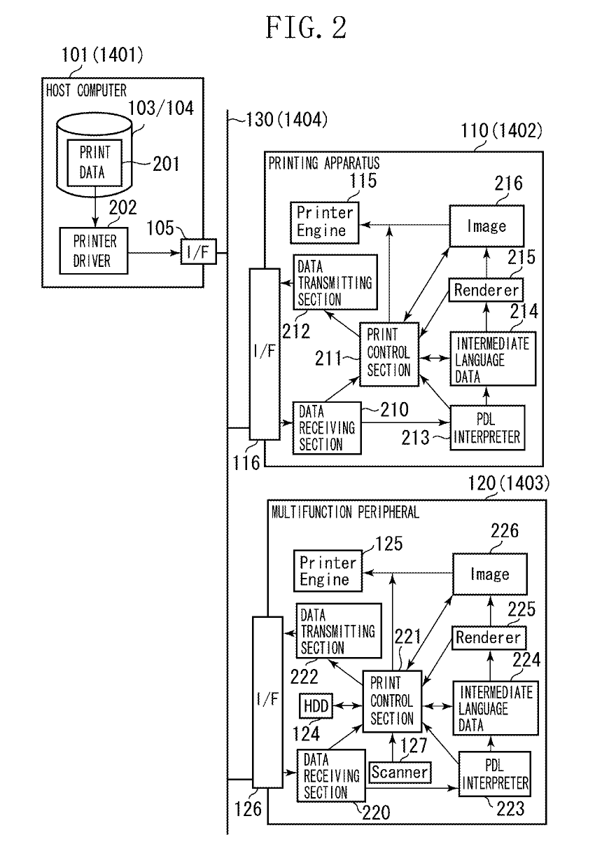

FIG. 2 is a schematic block diagram illustrating an arrangement of software modules, hardware components, and data in the printing system shown in FIG. 1. The CPU of each apparatus can control corresponding software modules and hardware components. The host computer 101 includes print data 201 stored in the RAM 103 or the HDD 104 and a printer driver 202 having the capability of printing the print data 201.

The printing apparatus 110 includes a data receiving section 210, a print control section 211, a data transmitting section 212, a PDL interpreter 213, intermediate language data 214, a renderer 215, image data 216, the printer engine 115, and the communication interface 116.

The data receiving section 210 can receive data from an external device via the communication interface 116. The data receiving section 210 can analyze the received data and determine a transfer destination of the reception data based on the result of analysis. The print control section 211 can execute various controls as later described. The data transmitting section 212 can transmit the data, via the communication interface 116, to an external device connected to the network 130. The PDL interpreter 213 can interpret the received print data.

More specifically, the PDL interpreter 213 can interpret PDL, such as PostScript (trademark) and LIPS (trademark), and can produce the intermediate language data 214 as a result of interpretation. The renderer 215 can bitmap expand the intermediate language data 214 and can produce the image data 216. The image data 216 and the intermediate language data 214 are collectively referred to as image data.

The multifunction peripheral 120 includes a data receiving section 220, a print control section 221, a data transmitting section 222, a PDL interpreter 223, intermediate language data 224, a renderer 225, image data 226, the printer engine 125, the HDD 124, and the communication interface 126.

The data receiving section 220 can receive data from an external device via the communication interface 126. The data receiving section 220 can analyze the received data and determine a transfer destination of the reception data based on the result of analysis. The print control section 221 can execute various controls as later described. The data transmitting section 222 can transmit the data, via the communication interface 126, to an external device connected to the network 130.

The PDL interpreter 213 can interpret the print data received. The PDL interpreter 223 can interpret the received print data. More specifically, the PDL interpreter 223 can interpret PDL, such as PostScript (trademark) and LIPS (trademark), and can produce the intermediate language data 224 as a result of interpretation. The PDL interpreter 223 may not be the same type as the PDL interpreter 213 and can interpret other PDL. The renderer 225 can bitmap expand the intermediate language data 224 and can produce image data 226.

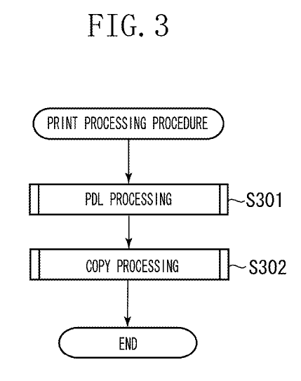

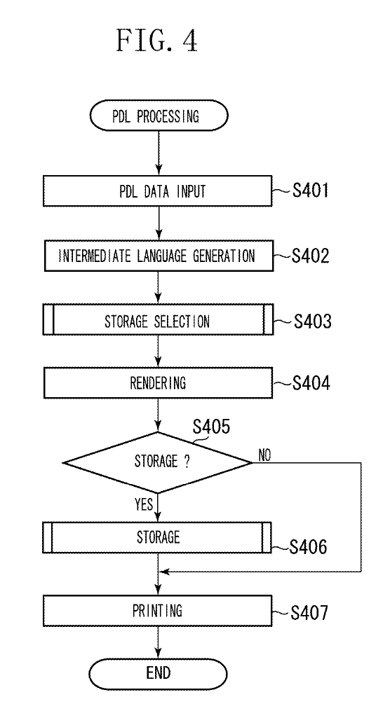

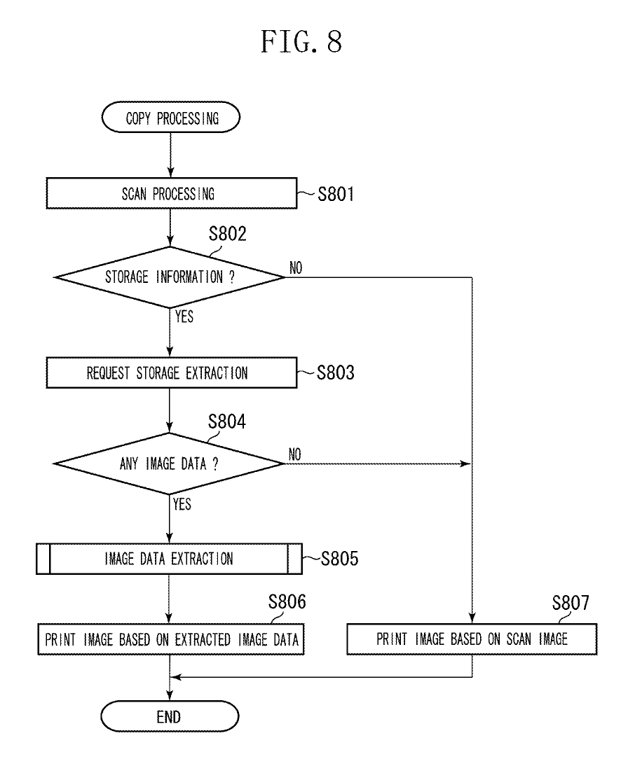

FIG. 3 is a flowchart showing a print processing procedure of the printing system. First, the printing system shown in FIGS. 1 and 2 performs PDL processing to create a print product (refer to step S301). Next, the printing system performs copy processing based on the created print product (refer to step S302). Details of the PDL processing (i.e., step S301) will be described below with reference to a flowchart of FIG. 4. Details of the copy processing (i.e., step S302) will be described below with reference to a flowchart of FIG. 8.

FIG. 4 is a flowchart showing PDL processing performed by the printing apparatus 110 that can receive document image data (PDL format data) produced from the host computer 100 and can perform image formation processing and image storage processing based on the received document image data.

In step S401, the data receiving section 210 of the printing apparatus 110 receives, via the communication interface 116, the PDL data produced from the host computer 100. In this case, it is required that the PDL interpreter 213 of the printing apparatus 110 can interpret the received PDL data, although the type of the PDL is not limited to a particular type.

In step S402, the PDL interpreter 213 receives the PDL data from the data receiving section 210, and produces the intermediate language data 214 based on the received PDL data.

The intermediate language data do not depend on the PDL type, as generally known. Therefore, any printer having a different PDL interpreter can execute the print processing based on the intermediate language data.

In step S403, the print control section 211 selects a storage destination (i.e., a storage device capable of storing document image data having an image data format).

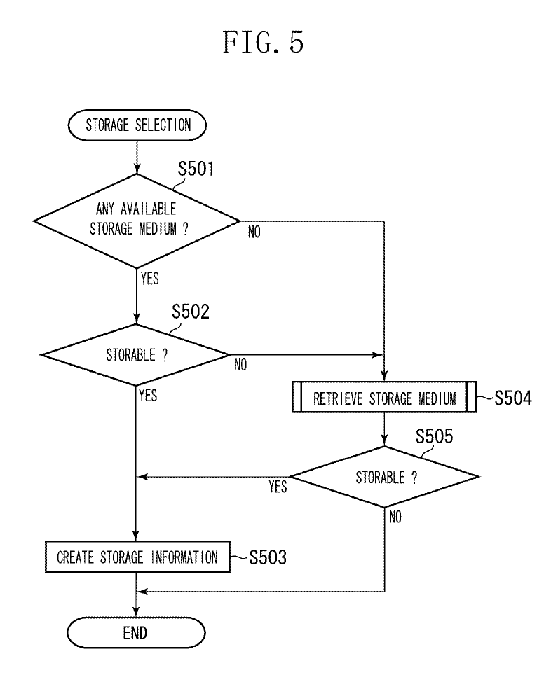

FIG. 5 is a flowchart showing storage selection processing performed in step S403. In step S501, the print control section 211 determines whether any storage medium (ROM or HDD) is present in the printing apparatus 110. When the printing apparatus 110 has a storage medium (i.e., YES in step S501), the processing flow proceeds to step S502. On the other hand, when no storage medium is present in the printing apparatus 110 (i.e., NO in step S501), the processing flow proceeds to step S504.

In step S502, the print control section 211 calculates a data size of image data producible from the document image data formatted as intermediate language data. Then, the print control section 211 compares the calculated data size to an available (remaining) capacity of the storage medium, to determine whether the document image data formatted as image data can be stored in the storage medium of the printing apparatus 110.

The data size of the image data producible from the intermediate language data 214 can be determined with reference to the total page number, resolution, and gradation number. For example, in the case of monochrome data having the resolution equal to 600 dpi and the gradation equal to 1 bpp (bits per pixel), the data size is approximately 4MB multiplied by the page number. It is also possible to determine the data size of the data encoded by an arbitrary encoding method.

When the printing apparatus 110 can store the produced data in its storage medium (i.e., YES in step S502), the processing flow proceeds to step S503. On the other hand, when the printing apparatus 110 cannot store the produced data (i.e., NO in step S502), the processing flow proceeds to step S504. In step S504, the print control section 211 executes the processing for retrieving a storage medium in other apparatus.

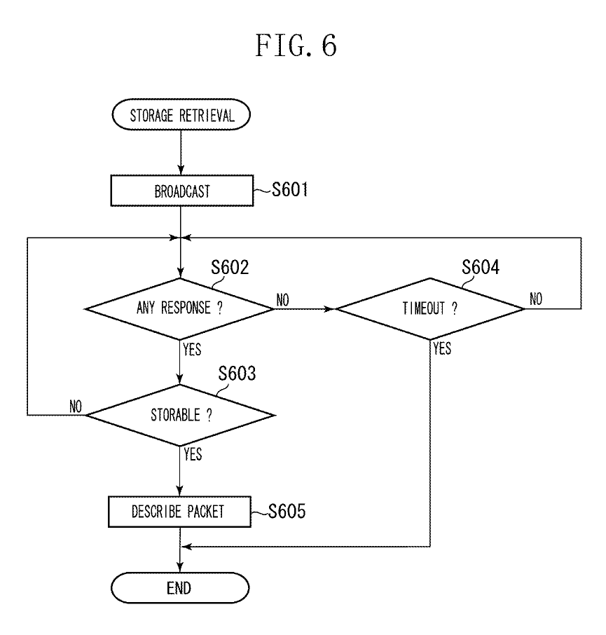

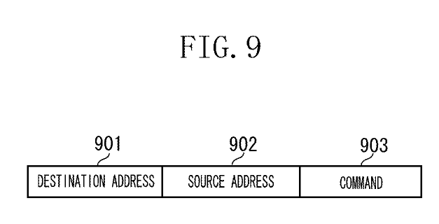

FIG. 6 is a flowchart showing storage retrieval processing performed in step S504. In step S601, the print control section 211 produces packet data shown in FIG. 9. The data transmitting section 212 transmits (i.e., broadcasts) the packet data to other devices via the network 130. The packet data include destination address 901 (i.e., address of printing apparatus 110), source address 902, and command 903 instructing “storage retrieval.” The method for retrieving an available storage portion is not limited to the above-described method.

In step S602, the print control section 211 determines whether any response to the broadcast of step S601 is returned. When the response is returned (i.e., YES in step S602), the processing flow proceeds to step S603. When no response is received (i.e., NO in step S602), the processing flow proceeds to step S604. In the present exemplary embodiment, the multifunction peripheral 120 returns a response.

In step S603, the print control section 221 determines whether the document image data can be stored in the HDD 124 of the multifunction peripheral 120. The decision processing of step S603 is similar to the decision processing of step S502 shown in the flowchart of FIG. 5. To execute the processing of step S603, the print control section 221 receives the document image data or the data size of the document image data from the printing apparatus 110 via the network 130. Although the decision processing of step S603 is performed in the multifunction peripheral 120, the printing apparatus 110 can perform similar decision processing.

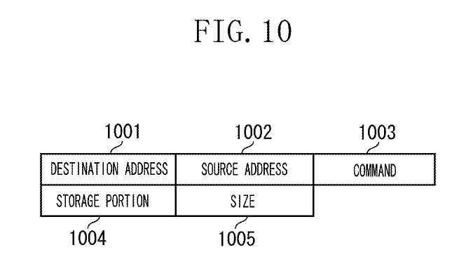

When the document image data can be stored in the HDD 124 of the multifunction peripheral 120 (i.e., YES in step S603), the processing flow proceeds to step S605. In step S605, the print control section 221 produces packet data shown in FIG. 10 and transmits the produced packet data to the printing apparatus 110 via the data transmitting section 222 and the communication interface 126. When the transmission of the packet data is accomplished, the processing flow proceeds to step S505 of FIG. 5.

The packet data of FIG. 10 include destination address 1001 (i.e., address of multifunction peripheral 120), source address 1002 (i.e., address of printing apparatus 110), command 1003 (i.e., command showing the storage retrieval result), storage portion 1004 (i.e., directory of storage device), and size 1005 (i.e., available capacity of storage device). Although the processing for producing the packet data is performed in the multifunction peripheral 120, the printing apparatus 110 can perform similar processing. In such a case, it is unnecessary to transmit the packet data.

On the other hand, when the document image data cannot be stored in the HDD 124 of the multifunction peripheral 120 (i.e., NO in step S603), the processing flow returns to step S602. In step S604, the print control section 211 of the printing apparatus 110 determines whether any timeout occurs in the storage retrieval processing. When the timeout occurs (i.e., YES in step S604), the print control section 211 decides that the storage of document image data is unfeasible and terminates the storage retrieval processing. Thus, the processing flow proceeds to step S505. On the other hand, when no timeout occurs (i.e., NO in step S604), the processing flow returns to step S602.

In step S505, the print control section 211 of the printing apparatus 110 determines whether the document image data can be stored in any storage device, based on the result of the above-described storage retrieval processing. When the document image data can be stored in any storage device (i.e., YES in step S505), the processing flow proceeds to step S503. On the other hand, when the document image data cannot be stored in any storage device (i.e., NO in step S505), the processing flow proceeds to step S404 of FIG. 4.

In step S503, the print control section 211 of the printing apparatus 110 creates storage information based on the results of steps S502 and S505. In the processing of step S503, the print control section 211 produces the packet data shown in FIG. 10. The packet data shown in FIG. 10 include destination address 1001 (i.e., address of the multifunction peripheral 120 that can store the document image data), source address 1002 (i.e., address of the printing apparatus 110 that has performed the PDL processing), and command 1003 (i.e., command showing the storage retrieval result), storage portion 1004 (i.e., directory of storage device), and size 1005 (i.e., available capacity of storage device). If the packet data shown in FIG. 10 is already produced, it is unnecessary to newly produce the packet data. After the above processing is accomplished, the processing flow proceeds to step S404 of FIG. 4.

In step S404, the renderer 215 executes rendering processing. More specifically, the renderer 215 bitmap expands the document image data formatted as intermediate language data and produces document image data formatted as image data. In step S405, the print control section 211 determines whether the produced image data can be stored. The print control section 211 performs this decision based on the storage selection result in step S403. When the storage of document image data is feasible (i.e., YES in step S405), the processing flow proceeds to step S406.

On the other hand, when the storage of document image data is unfeasible (i.e., NO in step S405), the processing flow proceeds to step S407. Namely, when the storage of document image data is feasible, the image data can be stored in the determined storage medium, and the print processing is performed in step S407.

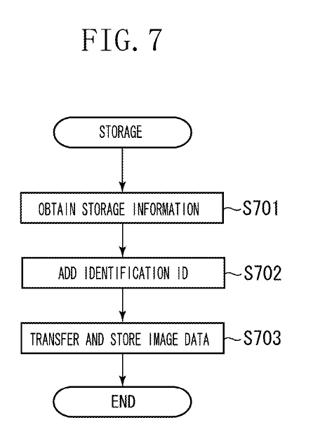

FIG. 7 is a flowchart showing storage processing performed in step S406. In step S701, the print control section 211 obtains storage information from the packet data shown in FIG. 10. In step S702, the print control section 211 produces identification (ID) and performs processing for correlating the produced identification (ID) to the document image data. The identification (ID) can be referred to as identification information. The identification information and the identification (ID) include specific information for identifying the stored document image data and the storage destination, such as IP address of the multifunction peripheral 120, directory information of the document image data stored in the storage device of the multifunction peripheral 120, and IP address of the printing apparatus 110 that has performed the PDL processing.

In step S703, the print control section 211 instructs transfer and storage of the identification (ID) and the document image data based on the storage information obtained in step S701. More specifically, the printing apparatus 110 transmits the document image data and the identification (ID) via the network 130 to the multifunction peripheral 120 that can store the document image data. The multifunction peripheral 120 stores the document image data in its storage device.

After accomplishing the above-described storage processing of step S406, the processing flow proceeds to step S407. In step S407, the print control section 211 produces, based on the identification (ID), an identification (ID) image which is composed with a predetermined region of the document image data. Then print control section 211 transmits the composed image data to the printer engine 125 that can print an image on a recording paper.

In composing two kinds of image data, the identification (ID) image produced from the identification (ID) is required to be recognizable in the copy processing so that the identification information is obtainable from the identification (ID) image. For example, the identification (ID) image may be a one-dimensional or two-dimensional bar code or an electronic watermark. Any other method can be used to compose two kinds of image data, if the identification information is obtainable from the identification (ID) image.

In the exemplary embodiment, the printing apparatus 110 performs the storage selection processing in step S403 and the identification (ID) production processing in the storage processing in step S406. However, the host computer 100 can perform similar processing.

After accomplishing the above-described PDL processing of step S301, the printing system performs the copy processing of step S302. Before starting the copy processing, the document image data has been already stored in the storage device of the multifunction peripheral 120 as a result of the above-described PDL processing.

FIG. 8 is a flowchart showing copy processing performed in step S302. In the following description, it is assumed that a paper document produced by the PDL processing is placed on a platen glass of an arbitrary multifunction peripheral connected to the network and the multifunction peripheral starts the copy processing in response to a copy instruction.

A multifunction peripheral executing the copy processing is equivalent to the multifunction peripheral 120 shown in FIG. 2. For example, the multifunction peripheral executing the copy processing has a print control section similar to the print control section 221 of the multifunction peripheral 120 shown in FIG. 2. Thus, the same reference numeral 221 is assigned to the print control section of the multifunction peripheral executing the copy processing.

In step S801, a scanner (not shown) of the multifunction peripheral reads the paper document and produces paper document image data. In step S802, the print control section 221 determines whether any identification (ID) image is present in the paper document image data. When the identification (ID) image is present (i.e., YES in step S802), the processing flow proceeds to step S803. When no identification (ID) image is present (i.e., NO in step S802), the processing flow proceeds to step S807.

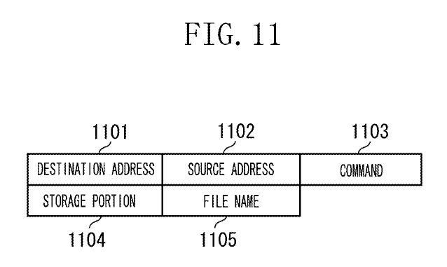

In step S803, the print control section 221 requests storage extraction processing. More specifically, the print control section 221 obtains the address of the multifunction peripheral 120 (i.e., device having stored the image data in the PDL processing) and the directory of the storage device in the multifunction peripheral 120 (i.e., device storing the image data) from the identification (ID) image. For example, the print control section 221 produces packet data shown in FIG. 11 based on the obtained information.

In the following description, obtaining the identification information from the image is, for example, equivalent to obtaining information from an identification (ID) image contained in the image.

In the following description, the identification information (or identification (ID)) of an image is regarded as being in an obtainable state, when the image includes the identification information and the identification information can be, for example, obtained by the multifunction peripheral 120.

In the following description, the identification information (or identification (ID)) of an image is regarded as being in an unobtainable state, when the image does not include the identification information, or when, though the identification information is included in the image, the identification information cannot be obtained, for example, by the multifunction peripheral 120.

FIG. 11 shows an example of the produced packet data. The packet data include destination address 1101 (i.e., address of the multifunction peripheral 120 storing the document image data), source address 1102 (i.e., address of the printing apparatus 110 that has performed the PDL processing), command 1103 (i.e., command requesting the storage extraction), storage portion 1104 (i.e., directory of the storage device), and file name 1105 (i.e., file name of the document image data).

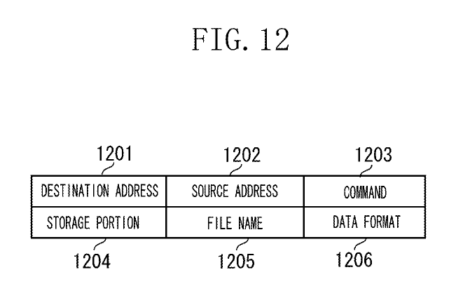

FIG. 12 shows an example of packet data returned from a device that has received the packet data shown in FIG. 11. The packet data include data format 1206 of the document image data in addition to the packet data information shown in FIG. 11.

Furthermore, in step S803, the print control section 221 transmits the packet data shown in FIG. 11 via the network 130 to the address of the multifunction peripheral 120 (i.e., the device storing the document image data). If the print control section 221 can communicate with the storage destination device, the print control section 221 can receive the packet data shown in FIG. 12 returned in response to the storage extraction request.

When the storage destination device is identical to the apparatus executing the copy processing, it is unnecessary to transmit the packet data via the network 130 in step S803 because the document image data can be obtained from its own storage device. When the print control section 221 cannot communicate with the storage destination device, the packet data describing NULL is returned.

In step S804, based on the command 1203 in the packet data shown in FIG. 12, the print control section 221 determines whether the document image data is present in the predetermined storage portion. When the extraction is feasible (when the document image data is present) (i.e., YES in step S804), the processing flow proceeds to step S805. When the extraction is unfeasible (when no document image data is present) (i.e., NO in step S804), the processing flow proceeds to step S807.

In step S805, the print control section 221 performs extraction of the document image data from the storage device of the multifunction peripheral 120 (i.e., the storage destination) based on the packet data shown in FIG. 12.

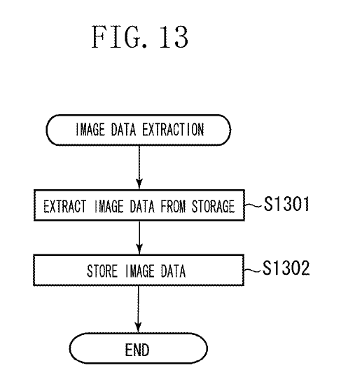

FIG. 13 is a flowchart showing image data extraction processing. In step S1301, the print control section 221 extracts the image data from the storage destination device based on the address 1201 of the packet data shown in FIG. 12. In step S1302, the print control section 221 stores the document image data into the HDD 124. When the above processing is accomplished, the processing flow proceeds to step S806.

In step S806, the printer engine 125 prints an image on a printing paper based on the extracted image data. When the extracted image data is formatted as intermediate language data, it is required to execute the rendering processing before starting the print processing of step S806.

On the other hand, when no document image data is present (i.e., NO in step S804), the print control section 221 expands the image data scanned in step S801 on the HDD 124 of FIG. 1 similar to the ordinary copy processing and the printer engine 125 prints an image on a recording paper based on the expanded image data (refer to step S807).

In this manner, the present exemplary embodiment can read, from a storage device, an image corresponding to the identification information involved in a scanned document and can output a printed image. Thus, the present exemplary embodiment can produce a high quality image rendered from the PDL data format, which is excellent compared to a print product produced based on the image data obtainable from a scanned document.

When the document is partly spoiled or handwritten, the present exemplary embodiment enables a user to obtain a clear printed image comparable to the original through the above-described processing.

In addition to the above-described fundamental operations, the printing system according to an exemplary embodiment can perform the following characteristic image processing and forming.

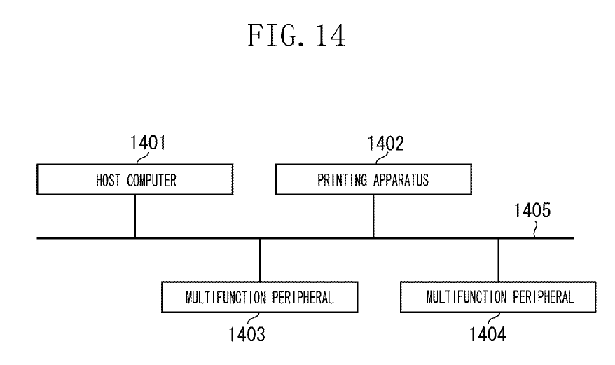

FIG. 14 is a block diagram illustrating a printing system that can read an image corresponding to a scanned document from a storage device and can print a readout image. The printing system shown in FIG. 14 includes a host computer 1401, a printing apparatus 1402, and two multifunction peripherals 1403 and 1404 which are connected via a network 1405 (e.g., LAN).

The devices included in the printing system of FIG. 14 are structurally similar to those shown in FIG. 1 and FIG. 2. Namely, the host computer 1401 is generally similar to the host computer 100. The printing apparatus 1402 is generally similar to the printing apparatus 110. Each of the multifunction peripherals 1403 and 1404 is generally similar to the multifunction peripheral 120.

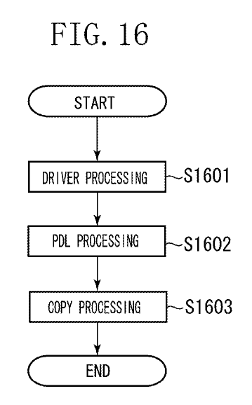

FIG. 16 is a fundamental flowchart showing a print processing procedure of the printing system shown in FIG. 14. Instep S1601, the host computer 1401 executes driver processing to produce PDL data and transmits the produced PDL data to the printing apparatus 1402. Subsequently, in step S1602, the printing apparatus 1402 executes the PDL processing based on the received PDL data and creates a printed product. Then, in step S1603, the printing system performs copy processing of the created printed product.

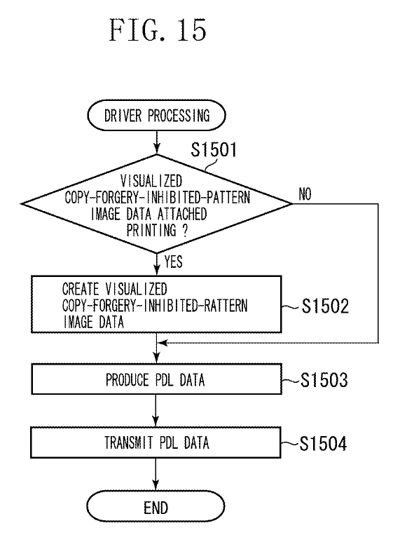

The driver processing of step S1601 will be described below in detail with reference to the flowchart of FIG. 15. In step S1501, a user can create document image data on the host computer 1401 and can instruct “adding a cfip image which is visualized upon copy” settings using a driver screen (not shown). When the upon-copy visualized cfip image addition setting is instructed (i.e., YES in step S1501), the processing flow proceeds to step S1502. Otherwise (i.e., NO in step S1501), the processing flow proceeds to step S1503.

The upon-copy visualized cfip image addition setting includes processes of composing the above-described identification (ID) with the document image data, printing out a composed image, and storing the document image data and the visualized cfip image data in an arbitrary storage device.

As described later, if a paper document created according to the upon-copy visualized cfip image addition setting is copied by a multifunction peripheral of the present printing system, the multifunction peripheral retrieves corresponding image data (i.e., document image data including visualized cfip image data) from the storage device based on the identification (ID) and forms an image on a printing paper based on the retrieved image data.

In step S1502, the printer driver 202 of the host computer 1401 creates visualized cfip image data. After the visualized cfip image data creation processing is accomplished, the processing flow proceeds to step S1503. The visualized cfip image data created in the present exemplary embodiment is formatted as image data. However, if desirable, the visualized cfip image data can be formatted as intermediate language data.

In step S1503, the printer driver 202 produces PDL data based on the document image data and the visualized cfip image data. When the upon-copy visualized cfip image addition setting is not instructed in step S1501, the printer driver 202 produces the PDL data based on only the document image data in step S1503.

In step S1504, the printer driver 202 transmits the PDL data to the printing apparatus 1402 via the communication interface 105 and the network 130. When the above-described processing is accomplished, the processing flow proceeds to step S1602. In step S1602, the printing apparatus 1402 executes the PDL processing. The PDL processing will be described below in detail.

When the upon-copy visualized cfip image addition setting is not instructed in step S1501, the ordinary printout operation is performed in step S1602. More specifically, the printing apparatus 1402 produces intermediate language data based on the received PDL document image data and produces (bit map) document image data. Then, the printing apparatus 1402 applies the image processing to the (bit map) document image data and forms an image on a recording paper. Next, the PDL processing performed when the upon-copy visualized cfip image addition setting is instructed in step S1501 will be simply described with reference to FIG. 4.

In step S401, the data receiving section 210 of the printing apparatus 1402 receives the PDL document image data and the PDL visualized cfip image data produced from the host computer 1401 via the communication interface 116. Instep S402, the PDL interpreter 213 of the printing apparatus 1402 receives the PDL data from the data receiving section 210 and produces the intermediate language data 214 consisting of visualized cfip image data and document image data based on the PDL data.

In step S403, the print control section 211 of the printing apparatus 1402 selects a storage destination and produces the packet data shown in FIG. 10. The selection of the storage destination is selecting a storage device that stores the document image data and the visualized cfip image data. The storage destination selection processing can be performed based on the above-described flowchart shown in FIG. 5.

According to the above-described selection processing, the storage destination is selected based on a comparison between the data size of the document image data and the storage capacity of the storage device. However, in the present exemplary embodiment, the data size of the document image data is added to the data size of the visualized cfip image data. The summed-up data size is compared to the storage capacity of the storage device, and the storage destination is selected based on the comparison result.

In step S404, the renderer 214 of the printing apparatus 1402 executes the rendering processing. The rendering processing includes a process of bitmap expanding the document image data and the visualized cfip image data formatted as intermediate language data and a process of producing document image data and visualized cfip image data formatted as image data.

In step S405, the print control section 211 of the printing apparatus 1402 determines whether the produced document image data and the visualized cfip image data formatted as image data can be stored based on the storage selection result of step S403. When the storage of the document image data and the visualized cfip image data is feasible (i.e., YES in step S405), the processing flow proceeds to step S406. On the other hand, when the storage of the document image data and the visualized cfip image data is unfeasible (i.e., NO in step S405), the processing flow proceeds to step S407.

In step S406, the print control section 211 of the printing apparatus 1402 obtains storage information from the packet data of FIG. 10 which is produced in step S403 and identifies the storage destination. The visualized cfip image data and the document image data are assigned file names and stored into the identified storage destination. In the step S406, the print control section 211 can compose or correlate the visualized cfip image data and the document image data beforehand for the storage. The same processing can be done in other exemplary embodiments.

The stored image can be expressed as a corresponding image corresponding to the identification information (or the identification (ID)). Furthermore, in step S406, the print control section 211 of the printing apparatus 1402 produces image data of the identification (ID). As described above, the identification (ID) contains storage information.

In step S407, the print control section 211 of the printing apparatus 1402 produces identification (ID) image data based on the identification (ID) and composes the produced identification (ID) image data with the document image data, and transmits the composed image data to the printer engine 125 of the printing apparatus 1402. The printer engine 125 creates a paper document by forming an image on a printing paper based on the composed image data.

In step S1603, the printing system performs the copy processing. The copy processing will be simply described with reference to the flowchart of FIG. 8. In the following description, it is assumed that the paper document including the cfip image and the identification (ID) image created by the above-described PDL processing is placed on the platen glass of the multifunction peripheral 1404, and the multifunction peripheral 1404 starts the copy processing in response to a copy instruction.

In step S801, the scanner 127 of the multifunction peripheral 1404 reads the paper document and produces paper document image data. In step S802, the print control section 221 of the multifunction peripheral 1404 determines whether the identification (ID) is involved in the paper document image data. When the identification (ID) is present (i.e., YES in step S802), the processing flow proceeds to step S803, when no identification (ID) is present (i.e., NO in step S802), the processing flow proceeds to step S807.

In step S803, the print control section 221 of the multifunction peripheral 1404 requests the storage extraction processing. To issue a storage extraction request, the print control section 221 produces storage information based on the identification (ID). Then, the print control section 221 produces the packet data shown in FIG. 11 based on the storage information. The packet data of FIG. 11 includes the description relating to storage information, as described above.

Furthermore, in step S803, the print control section 221 of the multifunction peripheral 1404 transmits the packet data of FIG. 11 to the address of the multifunction peripheral 1403 (i.e., storage destination device). If the print control section 221 can communicate with the multifunction peripheral 1403 (i.e., the storage destination device), the multifunction peripheral 1404 can receive the packet data shown in FIG. 12 returned in response to the storage extraction request.

The packet data shown in FIG. 12, as described above, include the storage information and a command showing a return value responding to the storage extraction request (i.e., an answer as to whether the document image data and the visualized cfip image data are present in the storage device).

In step S804, based on the command 1203 involved in the packet data of FIG. 12, the print control section 221 of the multifunction peripheral 1404 determines whether the document image data and the visualized cfip image data are present in the predetermined storage portion. When the extraction is feasible (when the image data are present) (i.e., YES in step S804), the processing flow proceeds to step S805. When the extraction is unfeasible (when no image data is present) (i.e., NO in step S804), the processing flow proceeds to step S807.

In step S805, the print control section 221 of the multifunction peripheral 1404 reads the document image data and the visualized cfip image data from the storage destination device based on the packet data shown in FIG. 12. In step S806, the print control section 221 of the multifunction peripheral 1404 composes two kinds of readout image data and sends the composed image data to the printer engine 125. The printer engine 125 forms an image on a recording paper based on the composed image data.

If the visualized cfip image data and the document image data are already composed in step S406, the composing processing in step S806 is unnecessary. Furthermore, no identification (ID) image data is composed with the document image data to be composed with the visualized cfip image data. The same thing is applied to other exemplary embodiments. However, if desirable, the identification (ID) image data can be composed with the document image data.

On the other hand, when no image data is present (i.e., NO in step S804), the print control section 221 expands the image data scanned in step S801 on the HDD 124 of FIG. 1 similar to the ordinary copy processing and the printer engine 125 prints an image on a recording paper based on the expanded image data (refer to step S807).

In the above-described exemplary embodiment, the host computer 1401 produces the visualized cfip image data. However, as a modified embodiment, the visualized cfip image data can be produced by the printing apparatus 110 that receives the PDL data. The same thing is applied to the other exemplary embodiments.

If the printing apparatus 110 produces the visualized cfip image data, the processing of step S1502 of the driver processing (step S1601) can be omitted. Furthermore, in step 1503 of the driver processing (step S1601), it is unnecessary to produce the PDL data based on the document image data and the visualized cfip image data. The PDL data can be produced based on only the document image data, and the produced PDL data can be transmitted to the printing apparatus 110 in step 1504 of the driver processing (step S1601).

Instead, for example in step S404 of the PDL processing (step S1602), it is required to produce the visualized cfip image data together with the document image data formatted as image data resulting from the rendering processing. Moreover, instead of the host computer 1401 or the printing apparatus 1402, the multifunction peripheral 1404 can produce the visualized cfip image data. In this case, the processing of step S1502 in step S1601 can be omitted.

Furthermore, in the step 1503 of the driver processing (step S1601), it is unnecessary to produce the PDL data based on the document image data and the visualized cfip image data. The PDL data can be produced based on only the document image data, and the produced PDL data can be transmitted to the printing apparatus 110 in step 1504 of the driver processing (step S1601).

Moreover, in the processing of step S1603, i.e., in the copy processing, it is unnecessary to correlate the visualized cfip image with the document image. Furthermore, the storage unit stores the document image unrelated to the visualized cfip image. Additionally, in the processing of step S1603, i.e., in the copy processing, it is necessary to produce the visualized cfip image data.

More specifically, in step S804, it is determined whether the document image data is present in the predetermined storage portion. When the extraction is feasible (when the image data is present) (i.e., YES in step S804), the processing flow proceeds to step S805. Then, in step S805, the print control section 221 of the multifunction peripheral 1404 reads the document image data from a storage destination device and produces the visualized cfip image data. Then, in step S806, the print control section 221 composes the readout document image data and the produced visualized cfip image data, and sends the composed image data to the printer engine 125. The printer engine 125 forms an image on a recording paper based on the composed image data.

As described above, according to the first exemplary embodiment, when a copy instruction of a paper document containing identification (ID) is issued, a pre-stored image corresponding to the instructed paper document is read out of a storage device. Then, a visualized cfip image is composed with the readout image, and a composed image is output on a printing paper. Or, a pre-stored composite image of the instructed paper document composed with the visualized cfip image is read out of a storage device, and the composite image is output on a printing paper. Accordingly, a restraining character string pattern, such as “COPY”, appears on the printout document and can be discriminated by human eyes.

Thus, the above-described exemplary embodiment can prevent a copy product created based on the image data read out of a storage device from being distributed undesirably. As described above, the visualized cfip image data and the document image data are stored into the storage unit in a composed or correlated state in the PDL processing of the present exemplary embodiment. However, this processing can be modified in the following manner.

For example, in the PDL processing, instead of storing the bit map (or intermediate language) formatted document image data into the storage unit, it is possible to store application formatted document image data into the storage unit or a server, so that only the cfip image data can be stored as bit map data (or intermediate language data).

Then, in the copy processing, the server can produce document image data from the application data and produce PDL data based on the visualized cfip image data and the document image data. The copying machine can produce a printout document including the visualized cfip image based on the PDL data. In this case, if the document image data is bit map data (or intermediate language data) producible from an EXCEL file, the application data can be expressed as “file name.xls.” The same thing is applied to other embodiments.

Second Exemplary Embodiment

According to the above-described first exemplary embodiment, a paper document containing identification (ID) is created by the PDL processing. And, a visualized cfip image is attached on a copy product obtainable by copying the paper document.

The second exemplary embodiment is different from the first exemplary embodiment in that both a cfip image and identification (ID) are added on a paper document created by the PDL processing. Similar to the first exemplary embodiment, a visualized cfip image is added on a copy product obtainable by copying the paper document.

Thus, the second exemplary embodiment is characterized in that a cfip image is attached on an original while a visualized cfip image (different from the cfip image) is attached on a copy product. In other words, the second exemplary embodiment can discriminate a genuine (i.e., original) based on a cfip image attached thereon. Furthermore, the second exemplary embodiment can discriminate a forgery (i.e., copy) based on the visualized cfip image attached thereon.

In the following description, the difference between the processing of the first exemplary embodiment and the processing of the second exemplary embodiment will be described in detail. The processing of step S1601 is shown in the flowchart of FIG. 15. The processing of step S1501 is identical to the processing described in the first exemplary embodiment.

In step S1502, the printer driver 202 of the host computer 1401 creates cfip image data and visualized cfip image data. When the creation processing is accomplished, the processing flow proceeds to step S1503. In the present exemplary embodiment, the created cfip image data and the visualized cfip image data are formatted as image data. However, it is possible to create the cfip image data and the visualized cfip image data formatted as intermediate language data.

In step S1503, the printer driver 202 produces PDL data based on the document image data, the cfip image data, and the visualized cfip image data. When the upon-copy visualized cfip image addition setting is not instructed in step S1501, the printer driver 202 produces the PDL data based on only the document image data in step S1503. The processing of step S1504 is similar to the processing described in the first exemplary embodiment.

In step S1602, the printing apparatus 1402 executes the PDL processing. When upon-copy visualized cfip image addition setting is not instructed in step S1501, the ordinary printout operation is performed in step S1602. More specifically, the printing apparatus 1402 forms an image on a recording paper based on the document image data involved in the received PDL data. The processing performed when the upon-copy visualized cfip image addition setting is instructed in step S1501 will be simply described with reference to the flowchart of FIG. 4.

The processing of step S401 is identical to the processing described in the first exemplary embodiment. In step S402, the PDL interpreter 213 of the printing apparatus 1402 receives the PDL data from the data receiving section 210. Then, based on the received PDL data, the PDL interpreter 213 produces the intermediate language data consisting of cfip image data and document image data as well as the intermediate language data consisting of visualized cfip image data and document image data.

In step S403, the print control section 211 of the printing apparatus 1402 selects a storage destination and produces the packet data shown in FIG. 10. The selection of the storage destination is selecting a storage device that stores the document image data and the visualized cfip image data. The storage destination selection processing is performed based on the above-described flowchart of FIG. 5, similar to the first exemplary embodiment.

In step S404, the renderer 214 of the printing apparatus 1402 executes the rendering processing. More specifically, the renderer 214 bitmap expands the intermediate language data consisting of the document image data and the cfip image data and produces document image data and cfip image data formatted as image data. Furthermore, the renderer 214 bitmap expands the intermediate language data consisting of the document image data and the visualized cfip image data and produces document image data and visualized cfip image data formatted as image data.

In step S405, the print control section 211 of the printing apparatus 1402 determines whether the produced document image data and the visualized cfip image data formatted as image data can be stored, based on the storage selection result in step S403. When the storage of the image data is feasible (i.e., YES in step S405), the processing flow proceeds to step S406. On the other hand, the storage of the image data is unfeasible (i.e., NO in step S405), the processing flow proceeds to step S407.

In step S406, the print control section 211 of the printing apparatus 1402 obtains storage information from the packet data shown in FIG. 10 produced in step S403 and identifies a storage destination. Then, the cfip image data and the visualized cfip image data and the document image data are assigned file names and stored into the identified storage destination. In this manner, not only the visualized cfip image data and the document image data stored in the second exemplary embodiment but also the cfip image data are stored in step S406.

Furthermore, in step S406, the print control section 211 of the printing apparatus 1402 produces image data of the identification (ID). As described above, the identification (ID) includes the storage information. In step S407, the print control section 211 of the printing apparatus 1402 produces identification (ID) image data based on the identification (ID) and composes the produced identification (ID) image data with the document image data and the cfip image data, and sends the composed image data to the printer engine 125 of the printing apparatus 1402.

The printer engine 125 creates a paper document by forming an image on a recording paper based on the composed image data. In this case, the document image data and the cfip image data composed with the identification (ID) image data are the bit map formatted document image data and cfip image data produced in step S404.

In step S1603, the printing system performs the copy processing. The copy processing will be simply described with reference to the flowchart of FIG. 8. In the following description, it is assumed that the paper document created by the above-described PDL processing is placed on the platen glass of the multifunction peripheral 1404, and the multifunction peripheral 1404 starts the copy processing in response to a copy instruction.

In step S801, the scanner 127 of the multifunction peripheral 1404 reads the paper document and produces paper document image data. In step S802, the print control section 221 of the multifunction peripheral 1404 determines whether the identification (ID) is present in the paper document image data. When the identification (ID) is present (i.e., YES in step S802), the processing flow proceeds to step S803. When no identification (ID) is present (i.e., NO in step S802), the processing flow proceeds to step S807.

In step S803, the print control section 221 of the multifunction peripheral 1404 requests the storage extraction processing. To issue a storage extraction request, the print control section 221 produces storage information based on the identification (ID). Then, the print control section 221 produces the packet data shown in FIG. 11 based on the storage information. The packet data of FIG. 11 includes the description relating to storage information, as described above.

Furthermore, in step S803, the print control section 221 of the multifunction peripheral 1404 transmits the packet data shown in FIG. 11 to the address of the multifunction peripheral 1403 (i.e., the storage destination device). If the print control section 221 can communicate with the multifunction peripheral 1403, the print control section 221 can receive the packet data shown in FIG. 12 returned in response to the storage extraction request.

The packet data shown in FIG. 12, as described above, include the storage information and a command showing a return value responding to the storage extraction request (i.e., an answer as to whether the document image data and the cfip image data and the visualized cfip image data are present in the storage device).

In step S804, based on the command 1203 involved in the packet data shown in FIG. 12, the print control section 221 of the multifunction peripheral 1404 determines whether the document image data and the visualized cfip image data and the cfip image data are present in the predetermined storage portion. When the extraction is feasible (when the image data are present) (i.e., YES in step S804), the processing flow proceeds to step S805. When the extraction is unfeasible (when no image data is present) (i.e., NO in step S804), the processing flow proceeds to step S807.

In step S805, the print control section 221 of the multifunction peripheral 1404 reads the document image data and the visualized cfip image data from the storage destination device based on the packet data shown in FIG. 12. In step S806, the print control section 221 of the multifunction peripheral 1404 composes two kinds of readout image data and sends the composed image data to the printer engine 125. The printer engine 125 forms an image on a recording paper based on the image data.

If the visualized cfip image data and the document image data are already composed in step S406, the composing processing in step S806 is unnecessary. Furthermore, no identification (ID) image data is composed with the document image data to be composed with the visualized cfip image data.

On the other hand, when no image data is present (i.e., NO in step S804), the print control section 221 expands the image data scanned in step S801 on the HDD 124 of FIG. 1 similar to the ordinary copy processing, and the printer engine 125 prints an image on a recording paper based on the expanded image data (refer to step S807).

In the above-described exemplary embodiment, the host computer 1401 produces the visualized cfip image data. However, as a modified embodiment, the visualized cfip image data can be produced by the printing apparatus 110 that receives the PDL data. The same thing is applied to the other exemplary embodiments.

If the printing apparatus 110 produces the visualized cfip image data, the processing of step S1502 of the driver processing (step S1601) can be omitted. Furthermore, in step 1503 of the driver processing (step S1601), it is unnecessary to produce the PDL data based on the document image data and the visualized cfip image data. The PDL data can be produced based on only the document image data, and the produced PDL data can be transmitted to the printing apparatus 110 in step 1504 of the driver processing (step S1601).

Instead, for example in step S404 of the PDL processing (step S1602), it is required to produce the visualized cfip image data together with the document image data formatted as image data resulting from the rendering processing. Moreover, instead of the host computer 1401 or the printing apparatus 1402, the multifunction peripheral 1404 can produce the visualized cfip image data. In this case, the processing of step S1502 in step S1601 can be omitted.

Furthermore, in the step 1503 of the driver processing (step S1601), it is unnecessary to produce the PDL data based on the document image data and the visualized cfip image data. The PDL data can be produced based on only the document image data and the produced PDL data can be transmitted to the printing apparatus 110 in step 1504 of the driver processing (step S1601).

Moreover, in the processing of step S1603, i.e., in the copy processing, it is unnecessary to correlate the visualized cfip image with the document image. Furthermore, the storage unit stores the document image unrelated to the visualized cfip image. Additionally, in the processing of step S1603, i.e., in the copy processing, it is necessary to produce the visualized cfip image data.

More specifically, in step S804, it is determined whether the document image data is present in the predetermined storage portion. When the extraction is feasible (when the image data is present) (i.e., YES in step S804), the processing flow proceeds to step S805. Then, in step S805, the print control section 221 of the multifunction peripheral 1404 reads the document image data from a storage destination device and produces the visualized cfip image data. Then, in step S806, the print control section 221 composes the readout document image data and the produced visualized cfip image data and sends the composed image data to the printer engine 125. The printer engine 125 forms an image on a recording paper based on the composed image data.

According to the above-described second exemplary embodiment, the paper document containing both the identification (ID) and the cfip image is created by the PDL processing. As described above, the visualized cfip image data and the document image data are stored into the storage unit in a composed or correlated state in the PDL processing of the present exemplary embodiment.

In the above-described secondary exemplary embodiment, the visualized cfip image data and the document image data (or the composed image data thereof) are read out of the storage unit and composed to create a printout document including the visualized cfip image. However, this processing can be modified in the following manner. For example, a printout document with a character string pattern appearing thereon can be created by prohibiting the printing of a cfip image containing paper document based on the image data read out of a storage unit.

Third Exemplary Embodiment

According to the above-described second exemplary embodiment, a paper document containing a cfip image and identification (ID) can be created by the PDL processing. And, a visualized cfip image is added to a copy product obtainable by copying the paper document.

The third exemplary embodiment is similar to the second exemplary embodiment in that a paper document containing a cfip image and identification (ID) can be created by the PDL processing. However, the third exemplary embodiment is differentiated in that (1) a visualized cfip image or (2) a cfip image is selectively added to a copy product obtainable when the paper document is copied.

More specifically, when a user instructing execution of the copy processing is identical to a user instructing execution of the PDL processing, a cfip image is added to the copy product. In this manner, the third exemplary embodiment allows a creator of the original to produce a copy product identical to the original. On the other hand, when a user instructing execution of the copy processing is not identical to a user instructing execution of the PDL processing, a visualized cfip image is added to the copy product.

In this manner, the printing system of the third exemplary embodiment can create a copy product differentiated from the original when the copy is requested by a person different from a creator of the original. Thus, the present exemplary embodiment can prohibit a third person to produce a copy product identical to the original. In the following description, the difference between the processing of the third exemplary embodiment and the processing of the second exemplary embodiment will be described in detail.

The processing of step S1601 is similar to the processing described in the second exemplary embodiment. The PDL data transmission processing performed in step S1504 is different from the processing described in the second exemplary embodiment. More specifically, in step S1504 of the second exemplary embodiment, the printer driver 202 transmits the PDL data to the printing apparatus 1402 via the communication interface 105 and the network 130. On the other hand, in the present exemplary embodiment, the printer driver 202 transmits user information together with the PDL data to the printing apparatus 1402. In the present exemplary embodiment, the user information represents user ID stored in the host computer 101.

In step S1602, the printing apparatus 1402 performs the PDL processing. When the upon-copy visualized cfip image addition setting is not instructed in step S1501, the ordinary printout operation is performed in step S1602 similar to the second exemplary embodiment. More specifically, the printing apparatus 1402 forms an image on a recording paper based on the document image data involved in the received PDL data.

The processing performed when the upon-copy visualized cfip image addition setting is instructed in step S1501 will be simply described with reference to the flowchart of FIG. 4. The processing of step S401 is identical to the processing described in the second exemplary embodiment.

In step S402, the PDL interpreter 213 of the printing apparatus 1402 receives PDL data from the data receiving section 210. Then, based on the received PDL data, the PDL interpreter 213 produces the intermediate language data consisting of cfip image data and document image data as well as the intermediate language data consisting of cfip image data and visualized cfip image data and document image data.

In step S403, the print control section 211 of the printing apparatus 1402 selects a storage destination and produces the packet data shown in FIG. 10. The selection of the storage destination is selecting a storage device that stores the document image data and the visualized cfip image data. The storage destination selection processing is performed based on the above-described flowchart of FIG. 5, similar to the second exemplary embodiment.

In step S404, the renderer 214 of the printing apparatus 1402 executes the rendering processing. More specifically, the renderer 214 bitmap expands the intermediate language data consisting of the document image data and the cfip image data, and produces document image data and cfip image data formatted as image data. Moreover, the renderer 214 bitmap expands the intermediate language data consisting of the document image data and the visualized cfip image data, and produces document image data and visualized cfip image data formatted as image data.

In step S405, the print control section 211 of the printing apparatus 1402 determines whether the produced document image data and the visualized cfip image data and the cfip image data formatted as image data can be stored, based on the storage selection result in step S403. When the storage of the image data is feasible (i.e., YES in step S405), the processing flow proceeds to step S406. On the other hand, when the storage of the image data is unfeasible (i.e., NO in step S405), the processing flow proceeds to step S407.

In step S406, the print control section 211 of the printing apparatus 1402 obtains storage information from the packet data of FIG. 10 which is produced in step S403 and identifies the storage destination. Then, the cfip image data, the visualized cfip image data, and the document image data are assigned file names and stored into the identified storage destination. The present exemplary embodiment is different from the second exemplary embodiment in that the above-described user information is stored in relation to the file.

In step S407, the print control section 211 of the printing apparatus 1402 produces identification (ID) image data based on the identification (ID) and composes the produced identification (ID) image data with the document image data and the cfip image data, and sends the composed image data to the printer engine 125 of the printing apparatus 1402.

The printer engine 125 forms an image on a recording paper based on the composed image data. The printer engine 125 creates a paper document by forming an image on a printing paper based on the composed image data. The document image data and the cfip image data composed with the identification (ID) image data are bit map formatted document image data and cfip image data produced in step S404.

In step S1603, the printing system performs the copy processing. The copy processing will be simply described with reference to the flowchart of FIG. 8. In the following description, it is assumed that the paper document created by the above-described PDL processing is placed on the platen glass of the multifunction peripheral 1404, and the multifunction peripheral 1404 starts the copy processing in response to a copy instruction.

Although not described in the second exemplary embodiment, the present exemplary embodiment requires authentication processing before a user instructs the copy processing at the multifunction peripheral 1404. More specifically, a user is required to input user information (i.e., user ID information) and a password on a display screen of the multifunction peripheral 1404.

In step S801, the scanner 127 of the multifunction peripheral 1404 reads the paper document and produces paper document image data. In step S802, the print control section 221 of the multifunction peripheral 1404 determines whether the identification (ID) is present in the paper document image data. When the identification (ID) is present (i.e., YES instep S802), the processing flow proceeds to step S803. When no identification (ID) is present (i.e., NO in step S802), the processing flow proceeds to step S807.

In step S803, the print control section 221 of the multifunction peripheral 1404 requests the storage extraction processing. To issue a storage extraction request, the print control section 221 produces storage information based on the identification (ID) and user information. Then, the print control section 221 produces a packet data based on the storage information.

Furthermore, in step S803, the print control section 221 of the multifunction peripheral 1404 transmits the produced packet data to the address of the multifunction peripheral 1403 (i.e., storage destination device). When the print control section 221 can communicate with the multifunction peripheral 1403, the multifunction peripheral 1404 can receive the packet data returned in response to the storage extraction request.

The packet data include the storage information and a command showing a return value responding to the storage extraction request (i.e., an answer as to whether the document image data and the visualized cfip image data and the cfip image data are present in the storage device).

In step S804, based on the command 1203 in the packet data shown in FIG. 12, the print control section 221 of the multifunction peripheral 1404 determines whether the document image data and the visualized cfip image data are present in the predetermined storage portion. When the extraction is feasible (when the image data are present) (i.e., YES in step S804), the processing flow proceeds to step S805. When the extraction is unfeasible (when no image data is present) (i.e., NO in step S804), the processing flow proceeds to step S807.

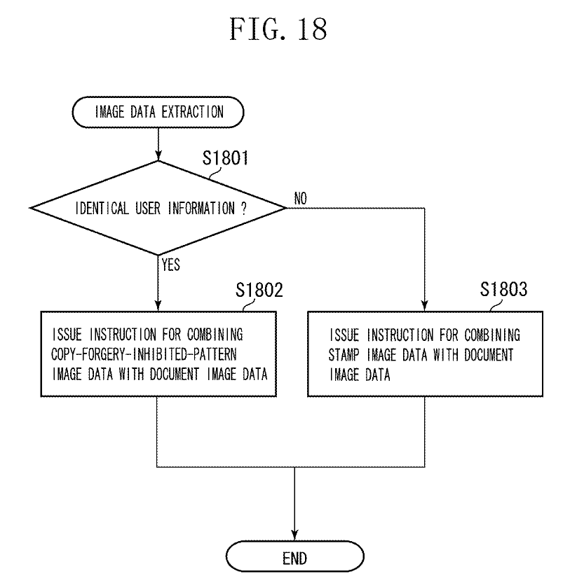

In step S805, the print control section 221 of the multifunction peripheral 1404 reads image data from the storage destination device based on the packet data shown in FIG. 12. The processing of step S805 will be described later with reference to the flowchart of FIG. 18. In step S806, the print control section 221 of the multifunction peripheral 1404 composes the image data, if necessary, and sends the composed image data to the printer engine 125.

The printer engine 125 forms an image on a recording paper based on the image data. For example, if plural kinds of image data (e.g., cfip image data+document image data) are transmitted from the print control section 221, the print control section 221 composes these image data and sends composed image data to the printer engine 125. On the other hand, when one kind of image data is transmitted from the print control section 221, the print control section 221 directly sends the received image data to the printer engine 125.

On the other hand, when no image data is present (i.e., NO in step S804), the print control section 221 expands the image data scanned in step S801 on the HDD 124 of FIG. 1 similar to the ordinary copy processing and the printer engine 125 prints an image on a recording paper based on the expanded image data (refer to step S807).

Subsequently, the processing of step S805 will be described in more detail with reference to the flowchart of FIG. 18. The processing is performed by the above-described storage destination device (more specifically, by the CPU of the storage destination device). Before starting the processing of the flowchart of FIG. 18, the CPU of the storage destination device already recognized the image data to be extracted based on the packet data transmitted from the printing apparatus 1402.

In step 1801, user information entered by a user on a display screen of the multifunction peripheral 1404 is compared to the user information stored in relation to the image data to be extracted. When the entered user information agrees with the stored user information (i.e., YES in step S1801), the processing flow proceeds to step S1802. Then, in step S1802, a command instructing composing the cfip image data and the document image data is sent to the multifunction peripheral 1404.

Furthermore, in addition to issuance of the above-described instruction, both the cfip image data and the document image data are transmitted to the multifunction peripheral 1404.

On the other hand, when the entered user information disagrees with the stored user information (i.e., NO in step S1801), the processing flow proceeds to step S1803. Then, in step S1803, a command instructing composing the visualized cfip image data and the document image data is sent to the multifunction peripheral 1404. Furthermore, in addition to issuance of the above-described instruction, both the visualized cfip image data and the document image data are transmitted to the multifunction peripheral 1404.

Other Exemplary Embodiment

The present invention can be embodied as a system, an apparatus, a method, a program or a storage medium (recording medium). More specifically, the present invention can be applied to a system including a plurality of devices (e.g., a computer, interface devices, a reader, and a multifunction peripheral), or can be applied to a single apparatus (such as, a copying machine, a multifunction peripheral, or a facsimile).

Furthermore, software programs for realizing the functions of the above-described exemplary embodiments (i.e., programs corresponding to the flowcharts described in the exemplary embodiments) can be supplied, directly or via storage or other media, to a system or an apparatus. A computer (or CPU or MPU) in the system or the apparatus can read and execute the program code supplied.

In this case, the program code read out from the storage medium can realize the functions of the exemplary embodiments. The equivalents of programs can be used if they possess comparable functions. Accordingly, when the functions or processes of the exemplary embodiments are realized by a computer, program code installed on the computer and a recording medium storing the programs are used to implement the present invention.

In other words, the present invention encompasses a computer program that can realize the functions or processes of the exemplary embodiments or any recording medium that can store the program. In this case, the type of programs can be any one of object code, interpreter program, and OS script data. A recording medium supplying the program can be selected from any one of a floppy disk (registered trademark), a hard disk, an optical disk, a magneto-optical disk, an MO, a CD-ROM, a CD-R, a CD-RW, a magnetic tape, a nonvolatile memory card, a ROM, and a DVD (DVD-ROM, DVD-R).

The method for supplying the program includes accessing a home page on the Internet using the browsing function of a client computer, when the home page allows each user to download the computer program of the present invention, or compressed files of the programs having automatic installing functions, to a hard disk or other recording medium of the user.

Furthermore, the program code constituting the programs of the present invention can be divided into a plurality of files so that respective files are downloadable from different home pages. Namely, the present invention encompasses WWW servers that allow numerous users to download the program files so that the functions or processes of the present invention can be realized on their computers.

Furthermore, enciphering the programs of the present invention and storing the enciphered programs in a CD-ROM or comparable recording medium is a method when the programs of the present invention are distributed to the users. The authorized users (i.e., users satisfying predetermined conditions) are allowed to download key information from a home page on the Internet. The users can decipher the programs with the obtained key information and can install the programs on their computers. When the computer reads and executes the installed programs, the functions of the above-described exemplary embodiments can be realized.

Furthermore, not only the functions of the above-described exemplary embodiment can be realized by a computer that executes the programs, but also an operating system (OS) running on the computer can execute part or all of the actual processing based on instructions of the programs.

Furthermore, the program code read out of a storage medium can be written into a memory of a function expansion board equipped in a computer or into a memory of a function expansion unit connected to the computer. In this case, based on an instruction of the program, a CPU provided on the function expansion board or the function expansion unit can execute part or all of the processing so that the functions of the above-described exemplary embodiments can be realized.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application Nos. 2005-316714 filed Oct. 31, 2005 and 2006-228962 filed Aug. 25, 2006, which are hereby incorporated by reference herein in their entirety.

What is claimed is:

1. An image forming apparatus comprising:
a storage processing unit configured to store a document image and a stamp image into a storage unit, wherein the stamp image is different from a copy-forgery-inhibited-pattern image;
a composing unit configured to compose the document image stored by the storage processing unit with the copy-forgery-inhibited-pattern image to produce a composite image; and
a forming unit configured to form the composite image produced by the composing unit on a sheet,
wherein when a copy instruction of the sheet is issued, the document image and the stamp image are read out of the storage unit, and the readout document image and the stamp image are composed and formed on a sheet.

2. The image forming apparatus according to claim 1, wherein the storage processing unit is configured to further store the copy-forgery-inhibited-pattern image into the storage unit,
wherein when a copy instruction of the sheet is issued, the document image and the stamp image are read out of the storage unit and the readout document image and the stamp image are composed and formed on a sheet, or the document image and the copy-forgery-inhibited-pattern image are read out of the storage unit and the readout document image and the copy-forgery-inhibited-pattern image are composed and formed on a sheet, based on user information.

3. The image forming apparatus according to claim 1, further comprising an identification information production unit configured to produce information for identifying the storage unit that stores the document image and the stamp image,
wherein the composing unit composes the identification information produced by the identification information production unit with the document image and the copy-forgery-inhibited-pattern image stored by the storage processing unit to produce a composite image,
wherein when a copy instruction of the sheet is issued, the document image and the stamp image are read out of the storage unit identified by the identification information on the sheet, and the readout document image and the stamp image are composed and formed on a sheet.

4. An image processing apparatus comprising:
a storage unit configured to store a stamp image and a document image which are correlated with each other, wherein the stamp image is different from a copy-forgery-inhibited-pattern image; and
an instruction issuing unit configured to issue an instruction for composing the document image and the stamp image mutually correlated and stored in the storage unit and forming a composite image on a sheet, in response to a copy instruction of a sheet including the document image and the copy-forgery-inhibited-pattern image composed and formed thereon.

5. The image processing apparatus according to claim 4, wherein
the storage unit stores the copy-forgery-inhibited-pattern image correlated with the document image and formed together with the document image on a sheet, and
in response to the copy instruction of a sheet, the instruction issuing unit issues an instruction for composing the document image and the stamp image mutually correlated and stored in the storage unit and forming a composite image on a sheet, or an instruction for composing the document image and the copy-forgery-inhibited-pattern image mutually correlated and stored in the storage unit and forming a composite image on a sheet, which is selected based on user information.

6. The image processing apparatus according to claim 5, wherein the storage unit stores information of a user having instructed composing the document image and the copy-forgery-inhibited-pattern image and forming a composite image on a sheet, in relation to the copy-forgery-inhibited-pattern image and the document image,
wherein in response to the instruction of forming the composite image, the instruction issuing unit selects an instruction for composing the copy-forgery-inhibited-pattern image and the document image correlated and stored in the storage unit and forming composite image on a sheet, when the information of the user having instructed the formation on the sheet agrees with information of a user issuing a copy instruction of the sheet, and
the instruction issuing unit selects an instruction for composing the stamp image different from the copy-forgery-inhibited-pattern image with document image and forming a composite image on a sheet, when the information of the user having instructed the formation on the sheet disagrees with the information of the user issuing the copy instruction of the sheet.

7. An image processing apparatus comprising:
a storage unit configured to store document image; and
an issuing unit configured to issue an instruction for composing the document image stored in the storage unit with a copy-forgery-inhibited-pattern image and forming a composite image on a sheet, or an instruction for composing the document image stored in the storage unit with a stamp image different from the copy-forgery-inhibited-pattern image and forming a composite image on a sheet, which is selected based on user information in response to a copy instruction of a sheet created by printing output the document image.

8. The image processing apparatus according to claim 7, wherein
the issuing unit selects an instruction for composing the document image stored in the storage unit with the copy-forgery-inhibited-pattern image and forming a composite image on a sheet, when information of a user having instructed creation of the created sheet agrees with information of a user issuing the copy instruction of the created sheet, and
the issuing unit selects an instruction for composing the document image stored in the storage unit with the stamp image different from the copy-forgery-inhibited-pattern image and forming a composite image on a sheet, when the information of a user having instructed creation of the created sheet disagrees with the information of the user issuing the copy instruction of the created sheet.

9. An image processing system including an image forming apparatus and an image processing apparatus, wherein
the image forming apparatus comprises:
a forming unit configured to form a document image on a sheet; and
a storage processing unit configured to store the document image formed on the sheet by the forming unit into a storage unit of the image processing apparatus,
the image processing apparatus comprises:
an issuing unit configured to issue an instruction for composing the document image stored in the storage unit with a copy-forgery-inhibited-pattern image and forming a composite image on a sheet, or an instruction for composing the document image stored in the storage unit with a stamp image different from the copy-forgery-inhibited-pattern image and forming a composite image on a sheet, which is selected in response to a copy instruction of a sheet on which the document image is formed.

10. An image processing system comprising:
an issuing unit configured to select an instruction for composing the document image stored in the storage unit with a copy-forgery-inhibited-pattern image and forming a composite image on a sheet, when information of a user having instructed creation of the document image on the sheet agrees with information of a user issuing the copy instruction of the sheet on which the document image is formed, and
the issuing unit selects an instruction for composing the document image stored in the storage unit with the stamp image different from the copy-forgery-inhibited-pattern image and forming a composite image on a sheet, when the information of the user having instructed creation of the document image disagrees with the information of the user issuing the copy instruction of the sheet on which the document image is formed.

11. The image processing system according to claim 9, wherein the forming unit of the image forming apparatus composes the document image with the copy-forgery-inhibited-pattern image and forms a composite image on a sheet.

12. A method for an image forming apparatus, comprising
storing a document image and a stamp image in a storage unit, wherein the stamp image is different from a copy-forgery-inhibited-pattern image;
composing the document image stored in the storage unit with the copy-forgery-inhibited-pattern image to produce a composite image; and
forming the composite image on a sheet, p1 wherein when a copy instruction of the sheet is issued, the document image and the stamp image are read out of the storage unit, and the readout document image and the stamp image are composed and formed on a sheet.

13. The method according to claim 12, further comprising storing the copy-forgery-inhibited-pattern image into the storage unit,
wherein when a copy instruction is issued, the document image and the stamp image are read out of the storage unit and the readout document image and the stamp image are composed and formed on a sheet, or the document image and the copy-forgery-inhibited-pattern image are read out of the storage unit, and the readout document image and the copy-forgery-inhibited-pattern image are composed and formed on a sheet, based on user information.

14. The method according to claim 12, further comprising:
producing identification information for identifying the storage unit that stores the document image and the stamp image;
composing the identification information with the document image and the copy-forgery-inhibited-pattern image to produce a composite image,
wherein when a copy instruction is issued, the document image and the stamp image are read out of the storage unit identified by the identification information, and the readout document image and the stamp image are composed and formed on a sheet.

15. A method for an image processing apparatus including a storage unit configured to store a document image and a stamp image which are correlated, wherein the stamp image is different from a copy-forgery-inhibited-pattern image, the method comprising:
issuing an instruction for composing the document image and the stamp image mutually correlated and stored in the storage unit and forming a composite image on a sheet, in response to a copy instruction of a sheet including the document image and the copy-forgery-inhibited-pattern image composed and formed thereon.

16. The method according to claim 15, wherein the storage unit stores the copy-forgery-inhibited-pattern image correlated with the document image and formed together with the document image on a sheet, and
further comprising issuing an instruction for composing the document image and the stamp image mutually correlated and stored in the storage unit and forming a composite image on a sheet, or an instruction for forming composing the document image and the copy-forgery-inhibited-pattern image mutually correlated and stored in the storage unit and forming a composite image on a sheet, which is selected based on user information.

17. The method according to claim 16, wherein the storage unit stores information of a user having instructed composing the document image and the copy-forgery-inhibited-pattern image and forming a composite image on a sheet, in relation to the copy-forgery-inhibited-pattern image and the document image.

18. The method according to claim 17, further comprising:
selecting an instruction for composing the copy-forgery-inhibited-pattern image and the document image correlated and stored in the storage unit and forming a composite image on a sheet, when the information of the user having instructed the formation on the sheet agrees with information of a user issuing a copy instruction of the sheet, and
selecting an instruction for composing the stamp image different from the copy-forgery-inhibited-pattern image with document image and forming a composite image on a sheet, when the information of the user having instructed the formation on the sheet disagrees with the information of the user issuing the copy instruction of the sheet.

19. A method for an image processing apparatus including a storage unit configured to store document image, the method comprising:
issuing an instruction for composing the document image stored in the storage unit with a copy-forgery-inhibited-pattern image and forming a composite image on a sheet, or an instruction for composing the document image stored in the storage unit with a stamp image different from the copy-forgery-inhibited-pattern image and forming a composite image on a sheet, which is selected based on user information in response to a copy instruction of a sheet created by printing output the document image.

20. The method according to claim 19, further comprising:
selecting an instruction for composing the document image stored in the storage unit with the copy-forgery-inhibited-pattern image and forming a composite image on a sheet, when information of a user having instructed creation of the created sheet agrees with information of a user issuing the copy instruction of the created sheet, and
selecting an instruction for composing the document image stored in the storage unit with the stamp image different from the copy-forgery-inhibited-pattern image, when the information of a user having instructed creation of the created sheet disagrees with the information of the user issuing the copy instruction of the created sheet.

21. A storage medium including computer-executable instructions stored thereon, which when executed by an image forming apparatus, causes the image forming apparatus to perform operations comprising:
storing a document image and a stamp image in a storage unit, wherein the stamp image is different from a copy-forgery-inhibited-pattern image;
composing the document image with the copy-forgery-inhibited-pattern image to produce a composite image; and
forming the composite image on a sheet;
further comprising, when a copy instruction of the sheet is issued:
reading the document image and the stamp image out of the storage unit; and
composing the readout document image and the stamp image on a sheet.

22. A storage medium including computer-executable instructions for controlling an image processing apparatus including a storage unit configured to store a document image and a stamp image which are correlated, wherein the stamp image is different from a copy-forgery-inhibited-pattern image, when the instructions are executed by the image processing apparatus, causes the image processing apparatus to perform operations comprising:
issuing an instruction for composing the document image and the stamp image mutually correlated and stored in the storage unit and forming a composite image on a sheet, in response to a copy instruction of a sheet including the document image and the copy-forgery-inhibited-pattern image composed and formed thereon.

23. A storage medium including computer-executable instructions for controlling an image processing apparatus including a storage unit configured to store document image, when the instructions are executed by the image processing apparatus, causes the image processing apparatus to perform operations comprising:
issuing an instruction for composing the document image stored in the storage unit with a copy-forgery-inhibited-pattern image and forming a composite image on a sheet, or an instruction for composing the document image stored in the storage unit with a stamp image different from the copy-forgery-inhibited-pattern image and forming a composite image on a sheet, which is selected based on user information in response to a copy instruction of a sheet created by printing output the document image.
